(19) United States
(12) Patent Application Publication
(10) Pub. No.: US 2013/0241947 A1
(43) Pub. Date: Sep. 19, 2013

(54) DISPLAY DEVICE, IMAGE PROCESSING DEVICE, IMAGE PROCESSING METHOD, AND COMPUTER PROGRAM

(71) Applicant: SONY CORPORATION, Tokyo (JP)

(72) Inventors: Yoichi HIROTA, Tokyo (JP); Kiyoshi IKEDA, Tokyo (JP); Akira FUJINAWA, Tokyo (JP)

(73) Assignee: SONY CORPORATION, Tokyo (JP)

(21) Appl. No.: 13/789,676

(22) Filed: Mar. 7, 2013

(30) Foreign Application Priority Data
Mar. 15, 2012 (JP) 2012-058937

(51) Int. Cl. G09G 5/02

(52) U.S. Cl. CPC G09G 5/02
USPC 345/589

(57) ABSTRACT

The present disclosure provides a display device including an image corrector that executes correction processing of an input image independently for each, color component, a display section that displays an output image of the image corrector, and an eyepiece optical section that projects a displayed image of the display section in such a manner that a predetermined angle of view is obtained. The image corrector executes correction processing of distortion generated by the eyepiece optical section after executing de-gamma processing of an input image for which gamma processing has been executed about each color component, and executes re-gamma processing to output a resulting image.

### BACKGROUND

The technique disclosed in the present specification relates to a display device obtained by combining display panels and lenses like e.g. a head-mounted display, an image processing device, an image processing method, and a computer program, and particularly to a display device, an image processing device, an image processing method, and a computer program that correct image distortion attributed to distortion involved in the lens by signal processing.

A display device mounted on the head to view images, i.e. the head-mounted display (HMD), is widely known. The head-mounted display has an optical unit for each of the left and right eyes and is so configured as to foe used in combination with a headphone to allow control of senses of vision and hearing. If it is so configured that the vision of the external world is completely blocked when it is mounted on the head, the feeling of virtual reality in viewing images increases. Furthermore, it is also possible for the head-mounted display to display different images for the left and right eyes, and a 3D (three-dimensional) image can be presented if images having a parallax are displayed for the left and right eyes.

As display sections for the left and right eyes in the head-mounted display, e.g. a high-resolution display panel formed of a liquid crystal or an organic electro-luminescence (EL) element can be used. Furthermore, if the image from the image display element is projected in an enlarged manner by an eyepiece optical system to set a wide angle of view and multiple channels are reproduced by a headphone, it will foe possible to reproduce a feeling of presence as if the user viewed the image at a movie theater.

It is known that the optical lens has distortion. For example, when a wide angle of view is ensured in a head-mounted display, there is a fear that complicated distortion and color deviation occur when a displayed image is viewed attributed to distortion of the lens used in the eyepiece optical system and thus the quality deteriorates.

Furthermore, if the number of lenses configuring the eyepiece optical system is increased to ensure a wide angle of view, the weight of the head-mounted display increases and therefore the burden of the user who wears it becomes larger. If the number of lenses is decreased for weight reduction, the distortion occurring in the respective lenses becomes larger and the lens system to correct the distortion becomes absent. As a result, it becomes difficult to ensure a wide angle of view.

A method of correcting the distortion occurring in the eyepiece optical system by signal processing is known. Specifically, if the eyepiece optical system has a distortion shown in FIG. 21, the image to be displayed on a display panel is corrected in advance in the direction opposite to that of the distortion characteristic of the eyepiece optical system as shown in FIG. 22. When the displayed image is viewed through the eyepiece optical system, it is observed as a normal image including no distortion. If the eyepiece optical system has such a characteristic as to distort the displayed image into a spool shape as shown in FIG. 21, the image is displayed on the display panel after image correction to distort the image into a barrel shape is performed for the original image as shown in FIG. 22. Thereby, the displayed image through the eyepiece optical system is viewed as the same image as the original image.

The distortion involved in the lens has a characteristic of slightly changing depending on the wavelength of light. Specifically, the distortion involved in the eyepiece optical system is as shown in FIG. 23, to be exact. Therefore, when the distortion correction shown in FIG. 22 is evenly applied to the color components of all of R, G, and B, the position on the image plane differs on each color component basis as shown in FIG. 24, so that the sharpness of the image deteriorates. To perform the distortion correction with higher accuracy, correction processing needs to be executed independently for each of the color components of RGB (Red-Green-Blue) as shown in FIG. 25.

For example, proposals have been made about a method in which image deterioration due to a chromatic aberration of the optical system is also corrected by individually performing distortion correction for image signals of the respective colors of RGB (refer to e.g. Japanese Patent Laid-opens Ho. Hei 9-61750, No. Hei 9-113823, No. 2001-186442, No. 2004-233869, and No. 2006-258802).

However, there is a fear that the imbalance of RGB occurs as an adverse effect caused when correction processing is executed independently for each of the color components of RGB. The imbalance of RGB is observed as a pseudo color with a hue at e.g. a thin white line and a white bright spot in the image.

### SUMMARY

There is a need for the technique disclosed in the present specification to provide an excellent display device, image processing device, image processing method, and computer program that can suitably correct image distortion attributed to distortion involved in the lens by signal processing when an image is displayed based on the combination of a display panel and a lens.

There is another need for the technique disclosed in the present specification to provide an excellent display device, image processing device, image processing method, and computer program that can suitably correct image distortion attributed to distortion involved in the lens by signal processing for each color component.

There is another need for the technique disclosed in the present specification to provide an excellent display device, image processing device, image processing method, and computer program that can suitably correct image distortion attributed to distortion involved in the lens by signal processing with suppression of an adverse effect due to signal processing independent for each color component.

According to an embodiment of the present technique, there is provided a display device including an image corrector configured to execute correction processing of an input image independently for each color component, a display section configured to display an output image of the image corrector, and an eyepiece optical section configured to project a displayed image of the display section in such a manner that a predetermined angle of view is obtained. The image corrector executes, about each color component, correction processing of distortion generated by the eyepiece optical section after executing de-gamma processing of an input image for which gamma processing has been executed, and executes re-gamma processing to output a resulting image.

According to another embodiment of the present technique, there is provided an image processing device including, for each color component, a de-gamma processor configured to execute de-gamma processing of an input image signal for which gamma processing has been executed, an image corrector configured to execute correction processing of distortion generated in projection by a predetermined eyepiece optical section for a linear input image resulting from the de-gamma processing, and a gamma processor configured to execute re-gamma processing of a linear image resulting from correction and output a resulting image.

According to a further embodiment of the present technique, there is provided an image processing method including, for each color component, executing de-gamma processing of an input image signal for which gamma processing has been executed, executing correction processing of distortion generated in projection by a predetermined eyepiece optical section for a linear input image resulting from the de-gamma processing, and executing re-gamma processing of a linear image resulting from correction and outputting a resulting image.

According to a still further embodiment of the present technique, there is provided a computer program that is described in a computer-readable format and is to cause a computer to function as an entity including, for each color component of an input image, a de-gamma processor configured to execute de-gamma processing of an input image signal for which gamma processing has been executed, an image corrector configured to execute correction processing of distortion generated in projection by a predetermined eyepiece optical section for a linear input image resulting from the de-gamma processing, and a gamma processor configured to execute re-gamma processing of a linear image resulting from correction and output a resulting image.

The computer program according to the embodiment of the present technique is defined as a computer program described in a computer-readable format so that predetermined processing may be realized on a computer. In other words, by installing the computer program according to the embodiment of the present technique in a computer, cooperative operation is exerted on the computer and the same operation and effects as those of the image processing device according to the embodiment of the present technique can be achieved.

According to the technique disclosed in the present specification, it is possible to provide an excellent display device, image processing device, image processing method, and computer program that can suitably correct image distortion attributed to distortion involved in the lens by signal processing with suppression of an adverse effect due to signal processing independent for each color component.

According to the technique disclosed in the present specification, in a display device obtained by combining a display panel end a lens, particularly the occurrence of color unevenness and the degradation of fineness as an adverse effect by signal processing independent for each color component can tae prevented and it becomes possible to display images with higher image quality.

Further other desires, features, and advantages of the technique disclosed in the present specification will become apparent from more detailed description based on an embodiment, to foe described later and the accompanying drawings.

### BRIEF DESCRIPTION OF THE DRAWINGS

FIG. 1 is a diagram, schematically showing the configuration of an image display system including a head-mounted display;

FIG. 2 is a block diagram of a function to correct distortion generated in a projected image of an eyepiece optical system for signal processing in the head-mounted display;

FIG. 3 is a diagram showing a configuration example of an image corrector that executes correction processing of an input image independently for each of color components of RGB;

FIG. 4 is a diagram showing an internal configuration example of a distortion correction block;

FIG. 5 is a diagram showing how an output image signal dout(k) is obtained by performing linear interpolation of values din(mₖ) and din(mₖ+1) of an input image signal by a decimal part sₖ of a reference signal ref(k);

FIG. 6 is a diagram showing values of the output image signal dout(k) in the case of performing linear interpolation of an input image signal din including a 100% bright spot of one pixel (sₖ=0.2);

FIG. 7 is a diagram showing values of the output image signal dout(k) in the case of performing linear interpolation of the input image signal din including a 100% bright spot of one pixel (sₖ=0.5);

FIG. 8 is a diagram showing values of the output image signal dout(k) in the case of performing linear interpolation of the input image signal din including a 100% bright spot of one pixel (sₖ=0.8);

FIG. 9 is a diagram illustrating a gamma curve;

FIG. 10 is a diagram showing the luminance of an output image in the case of performing linear interpolation of the input image signal din including a 100% bright spot of one pixel (sₖ=0.2);

FIG. 11 is a diagram showing the luminance of an output image in the case of performing linear interpolation of the input image signal din including a 100% bright spot of one pixel (sₖ=0.5);

FIG. 12 is a diagram showing the luminance of an output image in the case of performing linear interpolation of the input image signal din including a 100% bright spot of one pixel (sₖ=0.8);

FIG. 13 is a diagram showing the luminance of each color component of an output image in the case of performing linear interpolation of the input image signal din including a 100% white bright spot of one pixel;

FIG. 14 is a diagram showing the state in which a white bright spot of one pixel about which the totals of the luminance of each of color components of RGB do not correspond with each other at 100% due to image correction is viewed through an eyepiece optical system;

FIG. 15 is a diagram showing an internal configuration example of the distortion correction block;

FIG. 16 is a diagram showing the luminance of an output image in the case of performing linear interpolation after executing de-gamma processing of the input image signal din including a 100% bright spot of one pixel and then executing re-gamma processing (sₖ=0.2);

FIG. 17 is a diagram showing the luminance of an output image in the case of performing linear interpolation after executing de-gamma processing of the input image signal din including a 100% bright spot of one pixel and then executing re-gamma processing (sₖ=0.5);

FIG. 18 is a diagram showing the luminance of an output image in the case of performing linear interpolation after executing de-gamma processing of the input image signal din including a 100% bright spot of one pixel and then executing re-gamma processing (sₖ=0.8);

FIG. 19 is a diagram showing the luminance of each color component of an output image in the case of performing linear interpolation after executing de-gamma processing of the input image signal din including a 100% white bright spot of one pixel and then executing re-gamma processing;

FIG. 20 is a diagram showing the state in which a white bright spot of one pixel about which the totals of the luminance of each of color components of RGB correspond with each other at 100% due to image correction is viewed through the eyepiece optical system;

FIG. 21 is a diagram showing one example of image distortion occurring due to a lens;

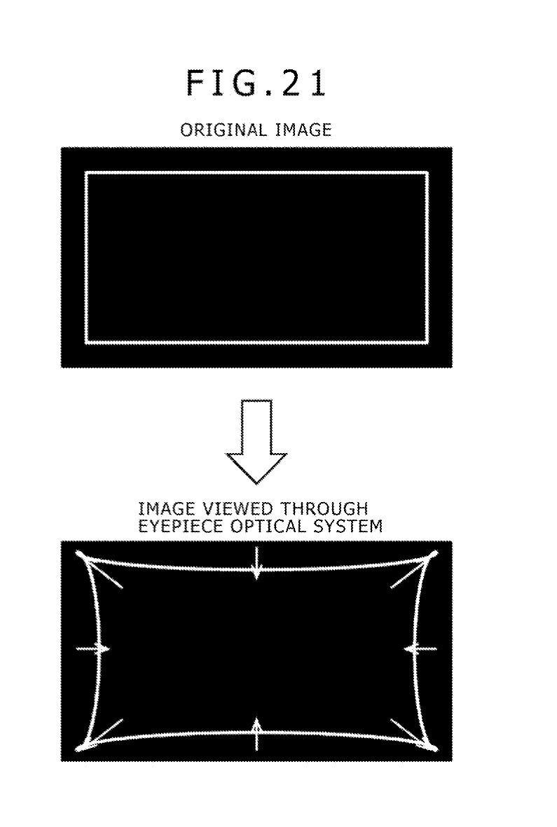

FIG. 22 is a diagram showing one example of correction of image distortion occurring doe to a lens by image processing;

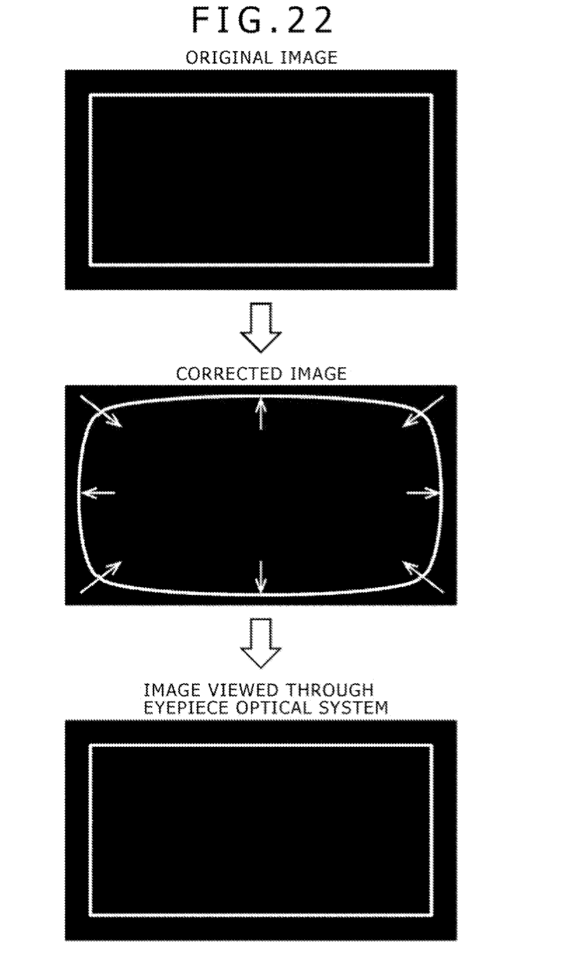

FIG. 23 is a diagram showing difference in image distortion occurring due to a lens among color components;

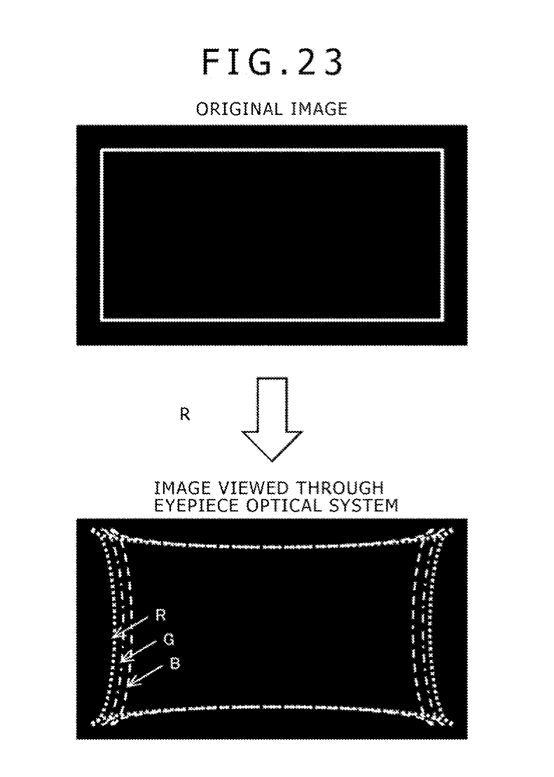

FIG. 24 is a diagram showing the result of execution of the same distortion correction for each of the color components; and

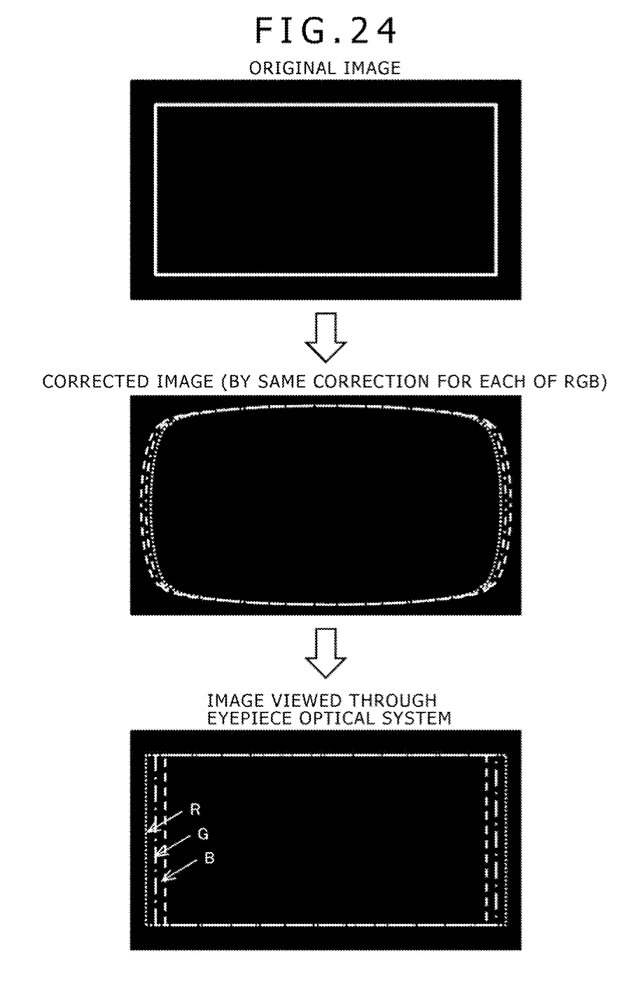

FIG. 25 is a diagram showing the result of execution of image correction independent for each of the color components.

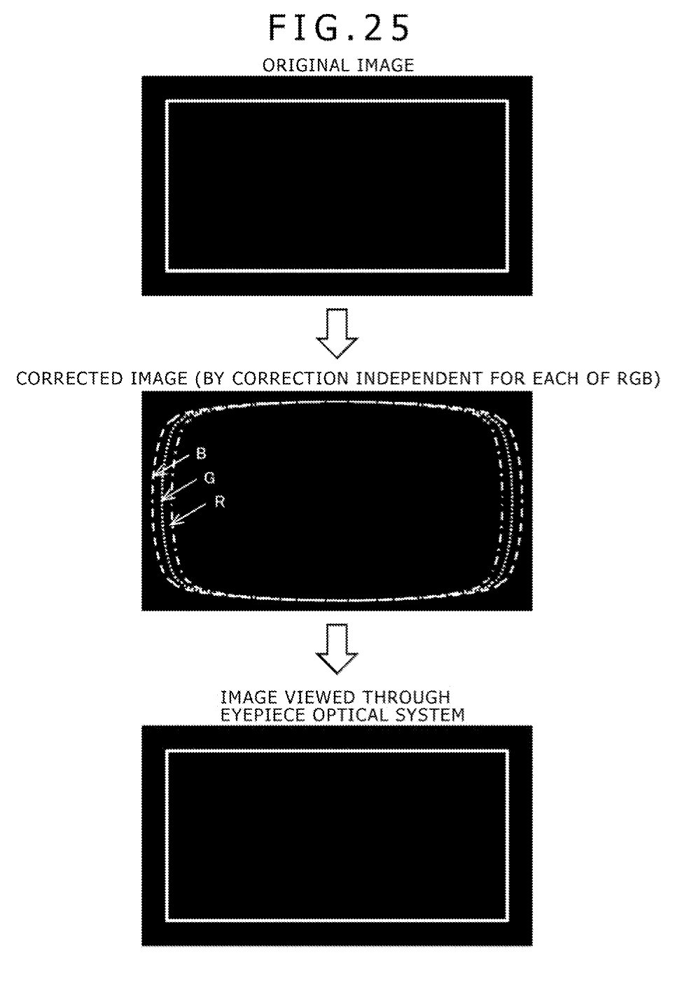

### DETAILED DESCRIPTION OF THE PREFERRED EMBODIMENT

An embodiment of the technique disclosed in the present specification will be described in detail below with reference to the drawings.

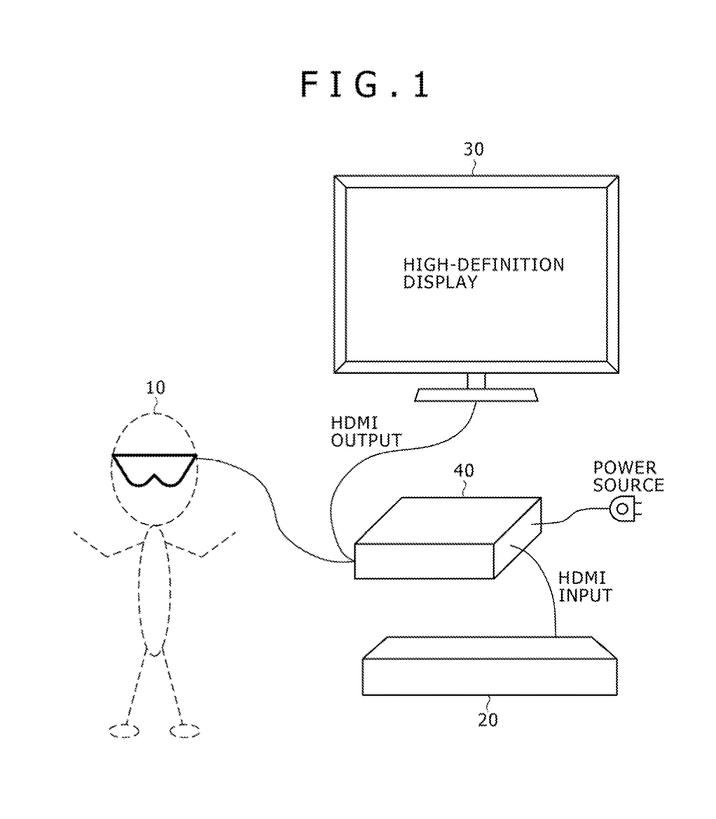

FIG. 1 schematically shows the configuration of an image display system, including a head-mounted display. The system shown in the diagram is composed of a Blu-ray disc reproduction device 20 serving as the source of content to be viewed, a front end box 40 that executes processing of an AV (Audio-Video) signal output from the Blu-ray disc reproduction device 20, a display device of a head-mounted type (head-mounted unit) 10 as an output destination of reproduced content of the Blu-ray disc reproduction device 20, and a high-definition display (e.g. HDMI-compatible television) 30 as another output destination of reproduced content of the Blu-ray disc reproduction device 20. One head-mounted display is configured with the head-mounted unit 10 and the front end box 40.

The front end box 40 is equivalent to an HDMI repeater that executes e.g. signal processing for an HDMI-input AV signal output from the Blu-ray disc reproduction device 20 and HDMI-outputs the resulting signal. Furthermore, the front end box 40 serves also as a two-output switcher that switches the output destination of the Blu-ray disc reproduction device 20 to either the head-mounted unit 10 or the high-definition display 30. Although the front end box 40 has two outputs in the example shown in the diagram, it may have three or more outputs. However, the front end box 40 makes the output destination of the AV signal for exclusive and places the highest priority on the output to the head-mounted unit 10.

The HDMI (high-definition multimedia interface) is an interface standard that is mainly used for the purpose of transmitting audio and video and aimed at digital home appliances. The HDMI is based on the digital visual interface (DVI) and uses the transition minimised differential signaling (TMDS) as a physical layer. This system conforms to e.g. HDMI 1.4.

A connection by an HDMI cable is made between the Blu-ray disc reproduction device 20 and the front end box 40 and between the front end box 40 and the high-definition display 30. Although it is also possible to make a connection by an HDMI cable also between the front end box 40 and the head-mounted unit 10, the AV signal may be serially transferred by using a cable based on another specification. However, the AV signal and power are supplied by one cable connecting the front end box 40 and the head-mounted unit 10, and the head-mounted unit 10 can also obtain driving power via this cable.

The head-mounted unit 10 includes independent display sections for the left eye and the right eye. Each display section uses a display panel formed of e.g. an organic EL element. Furthermore, the left and right respective display sections are equipped with a low-distortion, high-resolution eyepiece optical system with a wide viewing angle. If the image from the image display element is projected in an enlarged manner by the eyepiece optical system to set a wide angle of view and multiple channels are reproduced by a headphone, a feeling of presence as if the user viewed the image at a movie theater can be reproduced.

There is a fear that distortion is generated in a viewed image of the display panel attributed to distortion of the lens used in the eyepiece optical system. The distortion of the viewed image can be corrected by an optical system. However, in this method, a lens for distortion correction is added and therefore there is a fear that the weight of the head-mounted unit 10 increases and the burden of the user who wears it increases. So, in the present embodiment, a method of correcting the distortion generated in the eyepiece optical system by signal processing is employed.

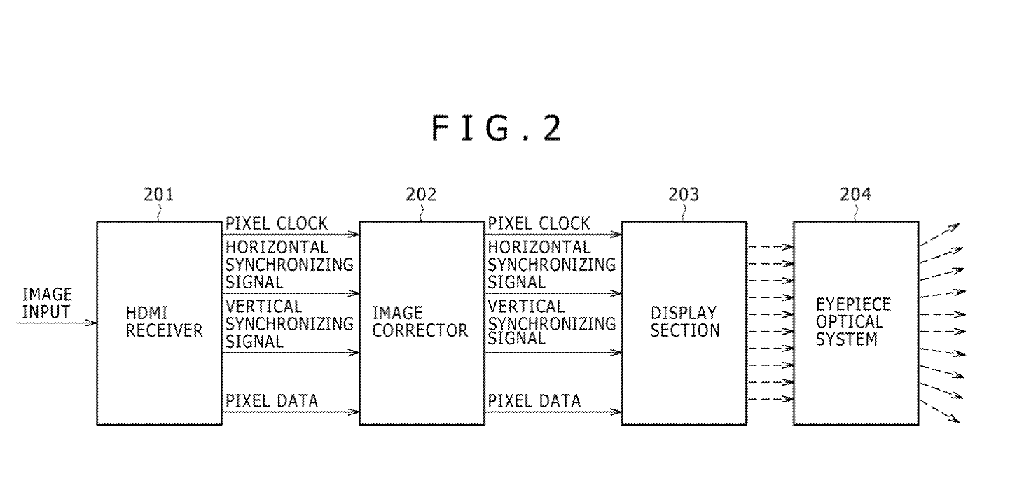

The “signal processing” here is equivalent to processing to give the presented image a distortion in the opposite direction to that of the distortion generated in the projected image of the eyepiece optical system. FIG. 2 shows a block diagram of the function to correct the distortion generated in the projected image of the eyepiece optical system by signal processing in the head-mounted display.

An image is input from an image source like the Blu-ray disc reproduction device 20 to an HDMI receiver 201. A distort ion is generated about the respective pixels of this input image due to passage through an eyepiece optical system 204. An image corrector 202 gives a distortion in the opposite direction to the respective pixels of the presented image to thereby perform motion compensation (MC), i.e. compensate for the displacement of the respective pixels generated due to the distortion, to generate a display image to which the preliminary opposite-distortion is applied. The distortion in the opposite direction, given to the pixels, will be referred to as the motion vector (MV) hereinafter. The start point of the motion vector is a pixel position on the input image and the end point thereof is the pixel position corresponding to this start point on the display image.

A display section 203 displays, on a display panel, the input image resulting from the correction with the distortion in the opposite direction by the image corrector 202. This displayed image is projected onto the retina of the eye of the viewer via the eyepiece optical system 204. Although a distortion is generated when the displayed image passes through the eyepiece optical system 204, a normal virtual image including no distortion is formed on the retina because the distortion in the opposite direction to that of this distortion has been given to the displayed image.

The image corrector 202 may be provided in either the head-mounted unit 10 or the front end box 40. Given that an image distortion based on the distortion parameter possessed by the lens configuring the eyepiece optical system 204 in the head-mounted unit 10 is corrected, providing the image corrector 202 in the head-mounted unit 10 allows the front end box 40 to output an image signal without being conscious of which head-mounted unit 10 is the output destination of the image signal.

The distortion involved in the lens configuring the eyepiece optical system 204 has a characteristic of slightly changing depending on the wavelength of light. Therefore, the image corrector 202 should execute the correction processing about the input image independently for each of the color components of RGB. However, there is a fear that the imbalance of RGB occurs as an adverse effect caused when the correction processing is executed independently for each of the color components of RGB.

In the following, a consideration will be made about the adverse effect caused when the correction processing is executed for the input image independently for each of the color components of RGB.

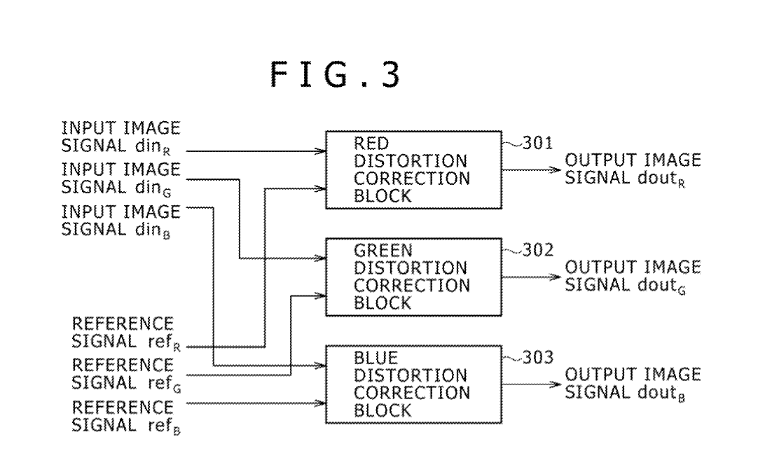

FIG. 3 shows a configuration example of the image corrector 202 that executes the correction processing for the input image independently for each of the color components of RGB. Input image signals din_{R}, din_{G}, and din_{B} and reference signals ref_{R}, ref_{G}, and ref_{B} are input to the image corrector 202 independently for each of the color components of RGB. Respective distortion correction blocks 301, 302, and 303 provided on each color component basis generate output image signals dout_{R}, dout_{G}, and dout_{B} from the input image signals din_{R}, din_{G}, and din_{B} by interpolation based on the reference signals ref_{R}, ref_{G}, and ref_{B}, respectively.

The following description is based on the assumption that the respective distortion correction blocks 301, 302, and 303 perform correction only in the horizontal direction for simplification of explanation. Furthermore, linear interpolation is employed as the interpolation method in the correction in the following description. Of course, the following description similarly holds even when the respective distortion correction blocks 301, 302, and 303 execute two-dimensional interpolation processing in the horizontal and vertical directions or multi-tap interpolation processing such as cubic interpolation.

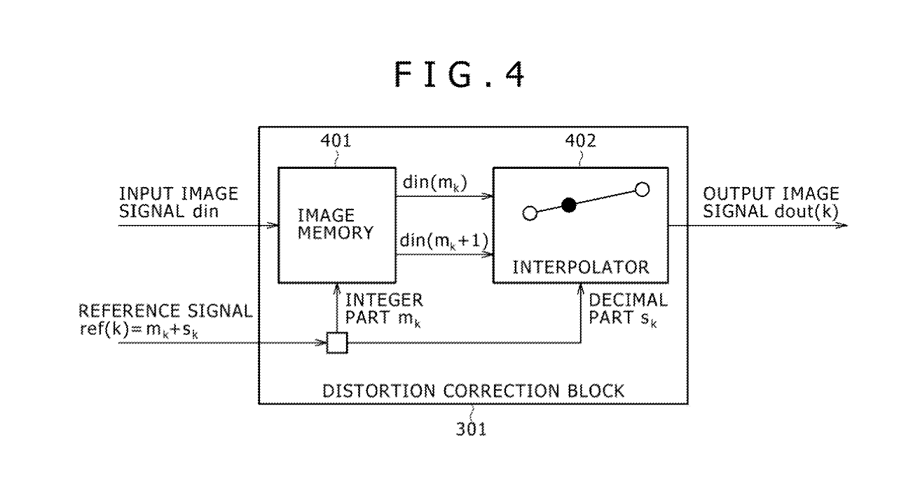

FIG. 4 shows an internal configuration example of the distortion correction block 301. Although the following description will treat only one color component, the configurations and processing details of the distortion correction blocks 302 and 303 about ail color components are the same.

An input image signal din and a reference signal ref(k) are input to the distortion correction block 301. The input image signal din is written into an image memory 401. The reference signal ref(k) represents a pixel position mₖ of the input image signal din to which an output image signal dout(k) of the k-th pixel position refers. However, the pixel position mₖ of the input image signal din to which the output image signal dout(k) refers is not necessarily an integer. Thus, the integer part of the reference signal ref(k) is represented as and the decimal part is represented as sₖ. The output image signal dout(k) is equivalent to the end point of a motion vector MV and ref(k) is equivalent to the start point of the motion vector. That is, the pixel position mₖ is the position resulting from distortion in the opposite direction to that of the distortion generated in the eyepiece optical system 204 regarding the k-th pixel of the output image.

In accordance with the value of the integer part mₖ of the reference signal ref(k), values din(mₖ) and din(mₖ+1-th) of the input image signal of adjacent mₖ-th and mₖ+1-th pixel positions are output from the image memory 401.

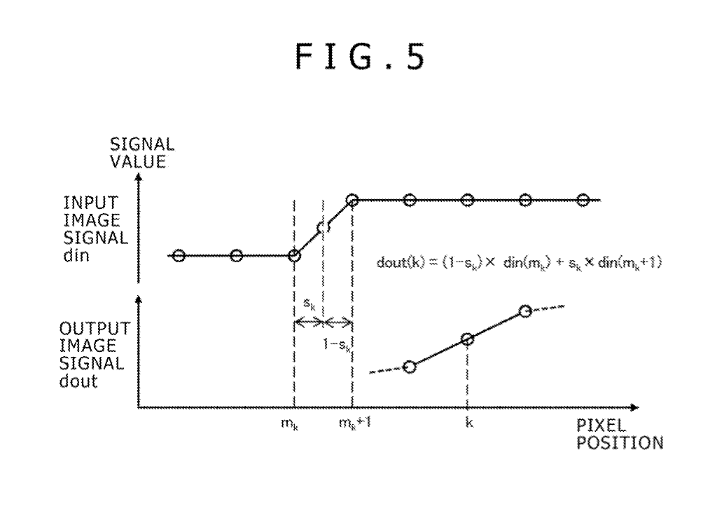

An interpolator 402 performs linear interpolation of the values din(mₖ) and din(mₖ+1) of the input image signal of adjacent two pixels, read out from the image memory 401, based on the value of the decimal part sₖ of the reference signal ref(k) as shown by the following expression (1) to obtain the output image signal dout(k) of the k-th pixel position. FIG. 5 illustrates how the output image signal dout(k) is obtained by performing the linear interpolation of the values din(mₖ) and din(mₖ+1) of the input image signal by the decimal part sₖ of the reference signal ref(k).

dout(k)=(1−sₖ)×din(mₖ)+sₖ×din(mₖ+1) (1)

A more detailed consideration will foe made below about the behavior in this distortion correction block 301 when a bright spot of one pixel exists in the input image din.

In general, the distortion generated in an image by the lens gently changes in the screen. Therefore, in the vicinity of the k-th output image dout(k), the reference signal ref(k) can be approximated as shown by the following expression (2).

ref(k+Δk)=mₖ+sₖΔk (2)

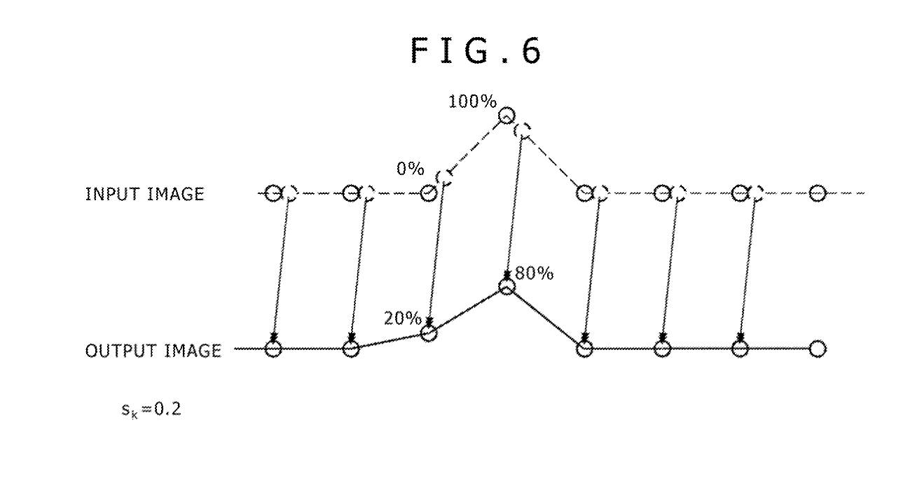

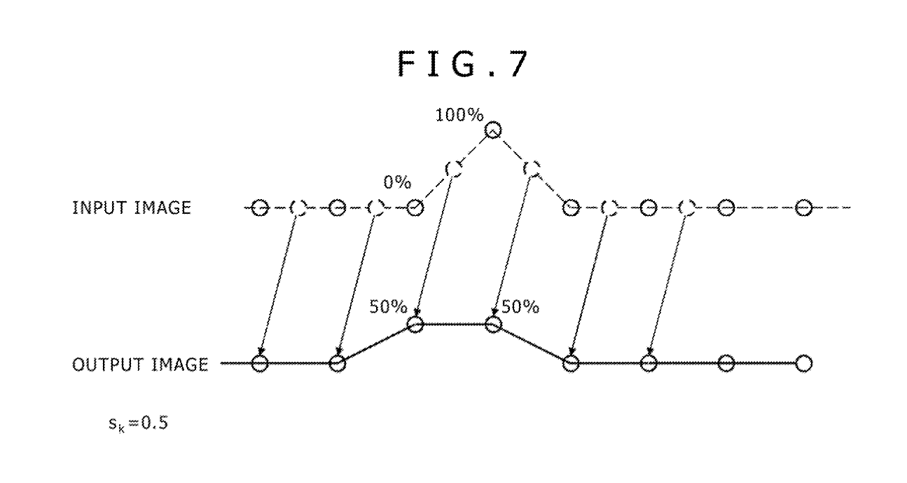

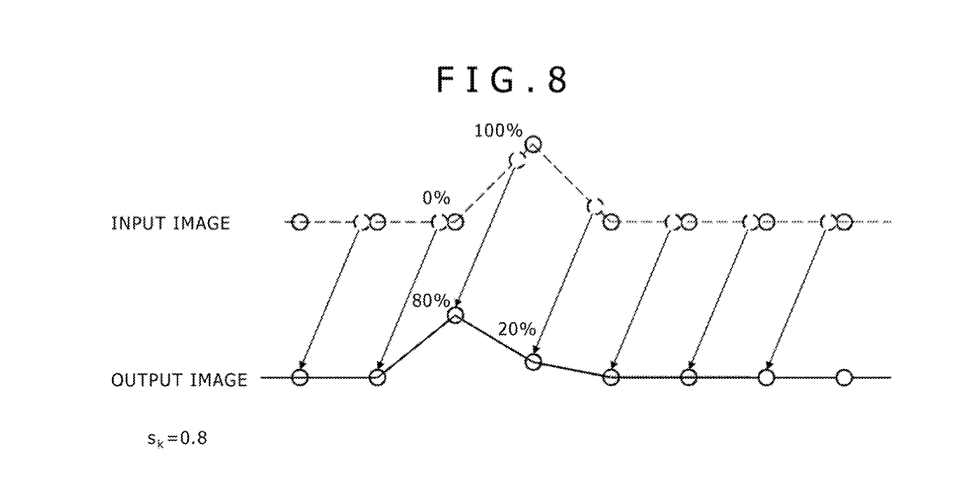

FIGS. 6 to 8 show the values of the output, image signal dout(k) resulting from correction when the decimal part sₖ of the reference signal ref(k) is changed to 0.2, 0.5, and 0.8, respectively, in the case of performing linear interpolation of the input image signal din including a 100% bright spot of one pixel in accordance with the above expression (1). Comparison of the respective diagrams proves that, although the signal value dout(k) of the output image changes depending on the value of the decimal part sₖ of the reference signal ref(k), the total of the signal value is 20+80=50+50=80+20=100% in each case and the 100% bright spot is distributed into plural pixels.

The point to which attention should be paid here is that the input image signal din has been subjected to gamma processing. In general, the image signal is subjected to bit reduction by gamma processing using a gamma curve like that shown in FIG. 5, so that the relationship between the signal value and the luminance value of the pixel is not a linear relationship, i.e. a proportional relationship. In the system configuration shown in FIG. 1, an image is displayed on the display panel after de-gamma processing is executed by the head-mounted unit 10 at the last output stage.

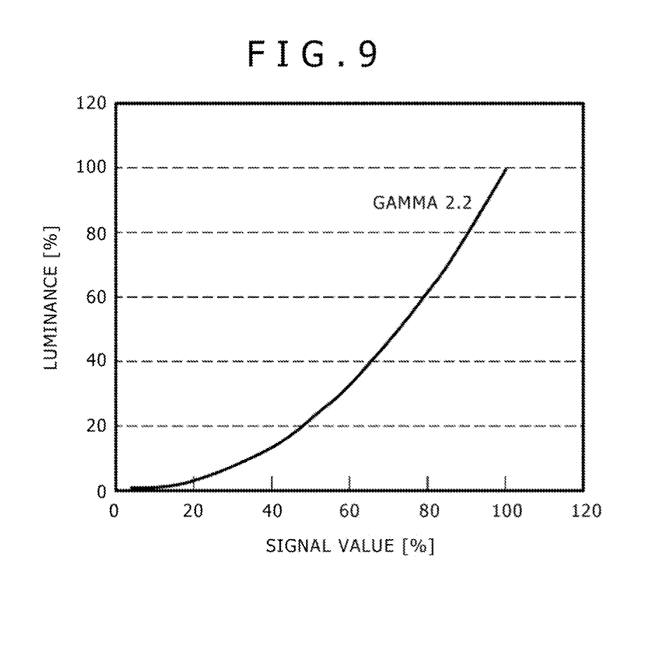

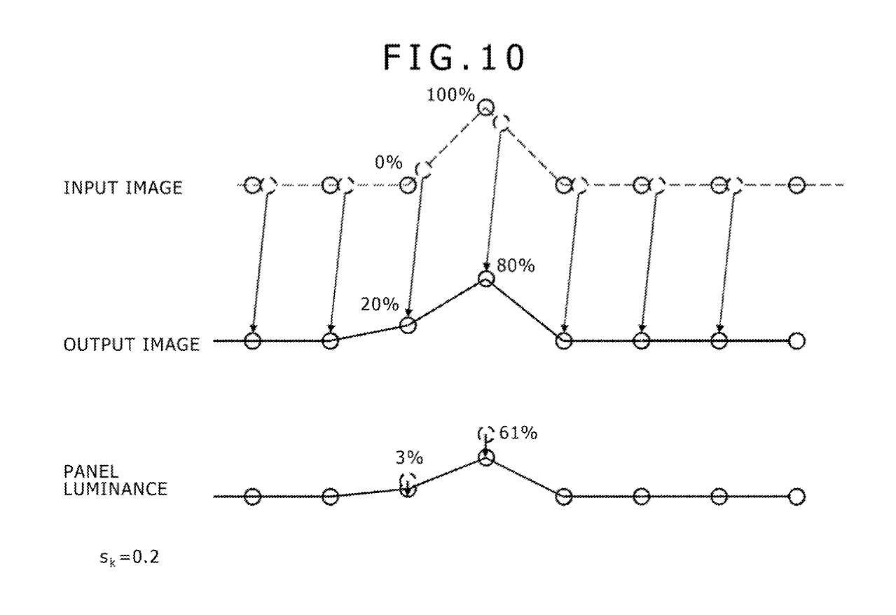

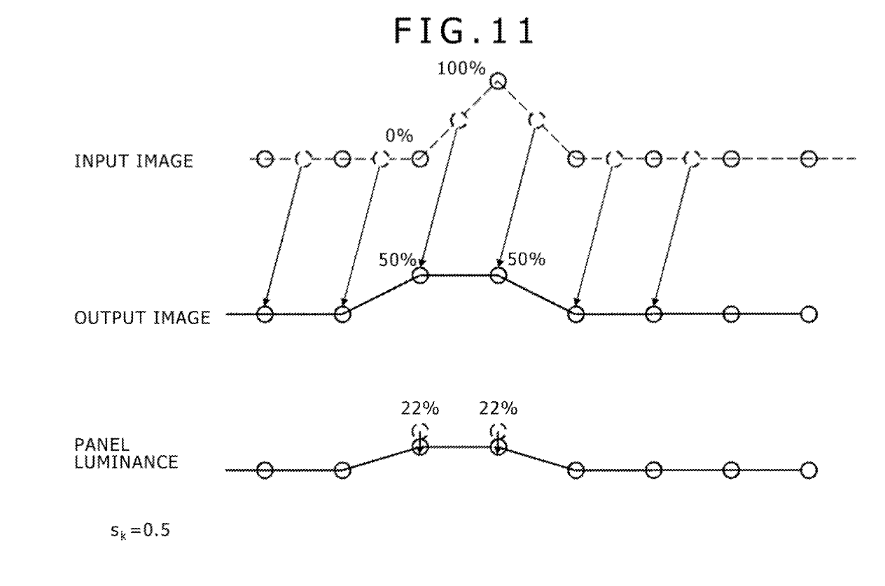

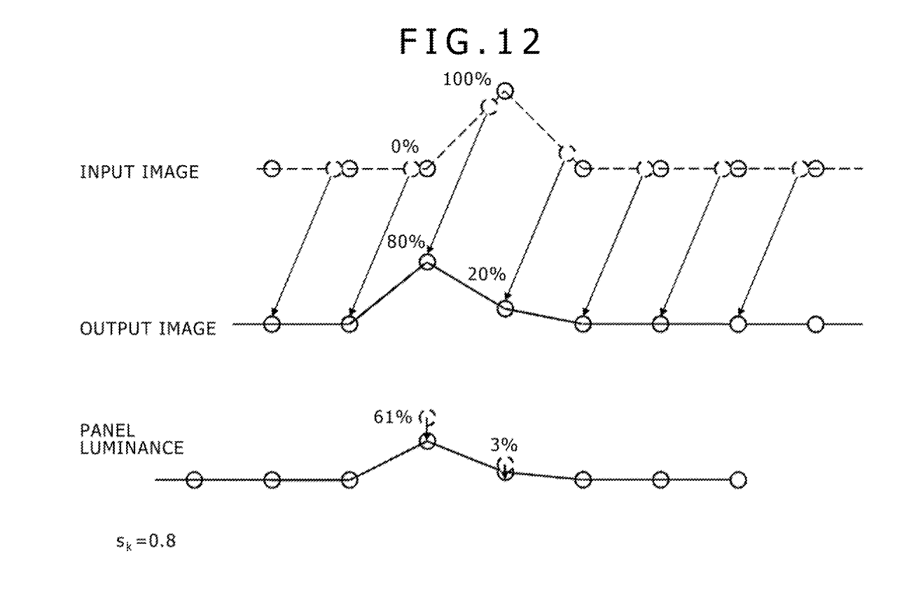

In the examples shown in FIGS. 6 to 8, the ordinate indicates the signal value. When the signal value is converted to the luminance in accordance with the gamma curve shown in FIG. 9, the luminance values shown in FIGS. 10 to 12 are obtained. Comparison of the respective diagrams proves the following point. Specifically, the luminance of the output image changes depending on the value of the decimal part sₖ of the reference signal ref(k). In addition, the total of the luminance also changes to 3+61=64%, 22+22=44%, and 61+3=64% when sₖ=0.2, 0.5, and 0.8, respectively. That is, the luminance changes due to correction by the image corrector 202.

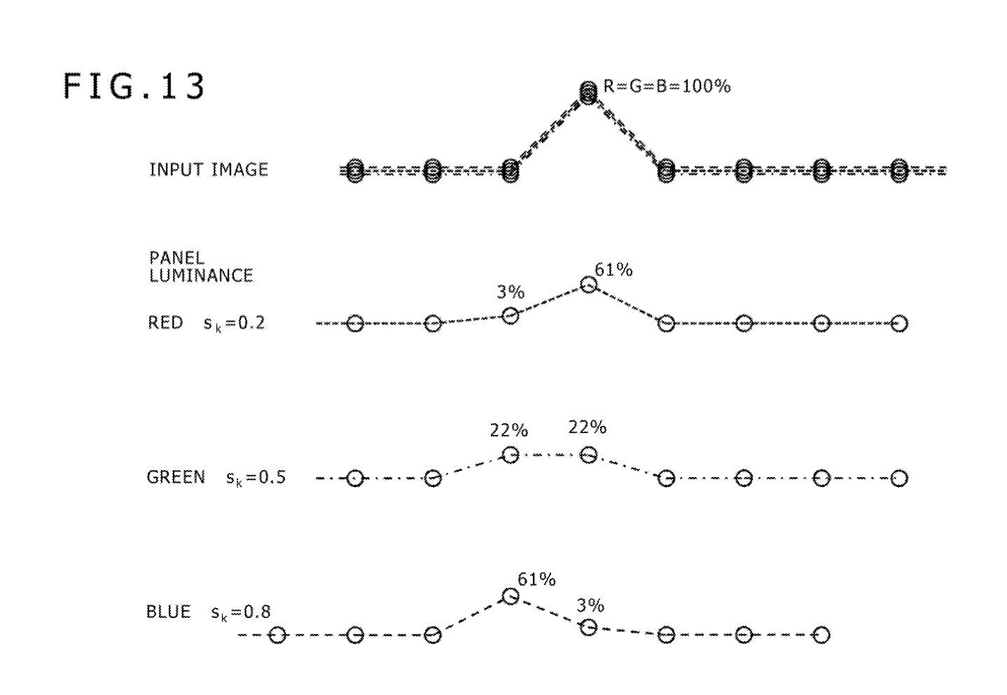

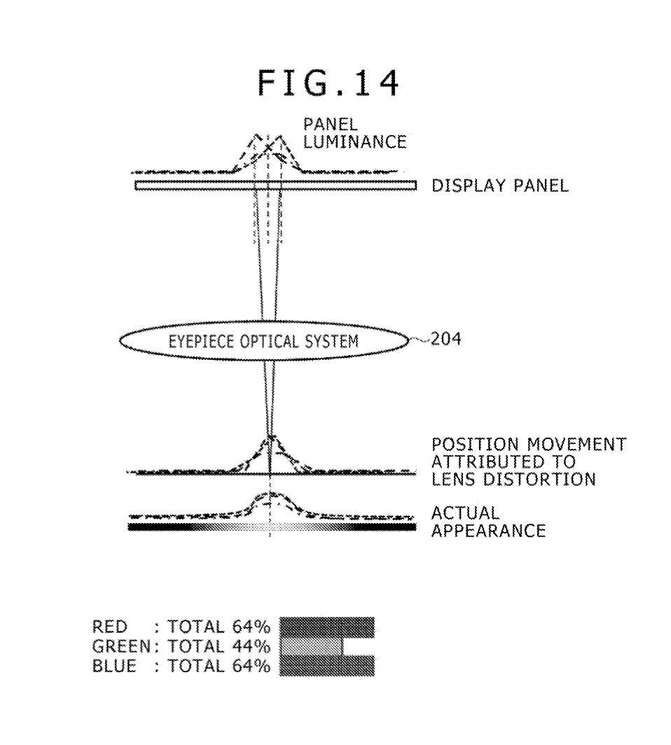

Based on the above, a consideration will be made below about the case in which a 100% white bright spot of one pixel exists in the input image. The reference signals of RGB are different from each other because of the chromatic aberration involved in the eyepiece optical system 204. For example, if the decimal part of the reference signal ref(k) at a certain output pixel position k is various, specifically R: sₖ=0.2, G: sₖ=0.5, and B: sₖ=0.8, as shown in FIG. 13, the total of the luminance of each color component of RGB is 3+61=64%, 22+22=44%, and 61+3=64% when sₖ=0.2, 0.5, and 0.8, respectively. The above-described values are the result of display on the display panel of the display section 203. When the image is viewed through the eyepiece optical system 204, the positions of the respective colors correspond with each other and the image is viewed as a normal image as shown in FIG. 14. However, because the total of the luminance of RGB is different, the color that should be -white originally is biased toward red or blue to be observed as a purplish color.

It will be effective to damp the input image signal by using a low-pass filter so that the image signal having a sharp change like a bright spot of one pixel may be prevented from being input to the image corrector 202. However, this scheme has a problem that fineness possessed by the original video is lost.

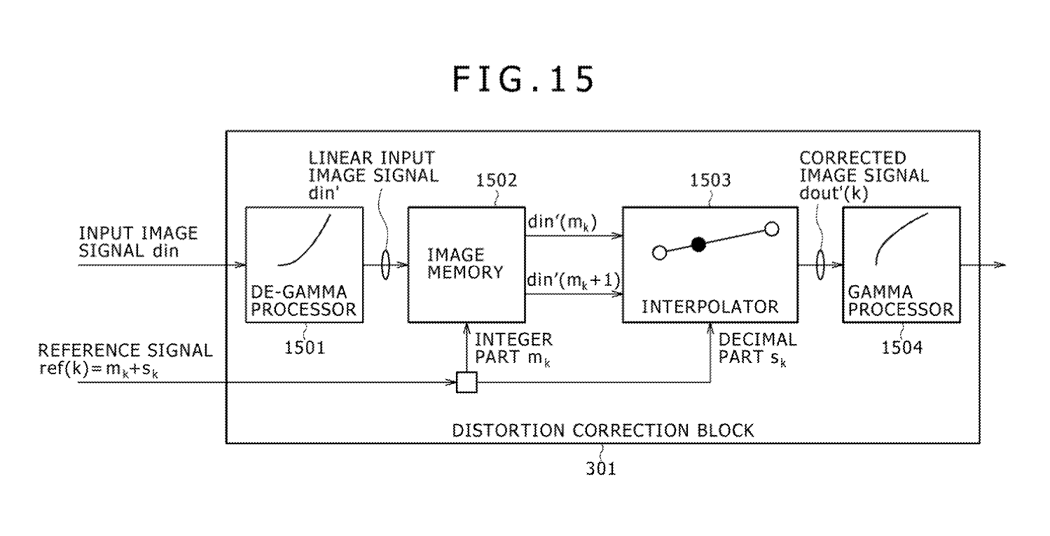

So, in the present embodiment, distortion correction is performed, after the input image signal is subjected to de-gamma processing to be temporarily converted to a linear image, and thereafter gamma processing is executed again to output the resulting image. FIG. 15 shows an internal configuration example of the distortion correction block 301 of this case. Although the following description will treat only one color component, the configurations and processing details of the distortion correction blocks 302 and 303 about all color components are the same.

The input image signal din and the reference signal ref(k) are input to the distortion correction block 301.

The input image signal din is subjected to de-gamma processing by a de-gamma processor 1501 disposed at the input stage and a linear input image signal din′ as its output is written into an image memory 1502.

The reference signal ref(k) represents the pixel position of the input image signal din to which the output image signal dout(k) of the k-th pixel position refers. The integer part mₖ of ref(k) is input to the image memory 1502 and the decimal part sₖ is input to an interpolator 1503.

In accordance with the value of the integer part mₖ of the reference signal ref(k), values din′ (mₖ) and din′ (mₖ+1) of the linear input image signal of adjacent mₖ-th and mₖ+1-th pixel positions are output from the image memory 1502.

The interpolator 1503 performs linear interpolation of the values din′ and din′ (mₖ+1) of the linear input image signal of adjacent two pixels, read out from the image memory 1502, based on the value of the decimal part sₖ of the reference signal ref(k) as shown by the following expression (3) to obtain a corrected image signal dout′ (k) of the k-th pixel position.

dout′(k)=(1=sₖ)×din′(mₖ)+sₖ×din′(mₖ+1) (3)

A gamma processor 1504 disposed at the output stage executes re-gamma processing of the linear corrected image signal dout′ (k) and outputs an output image signal dout(k).

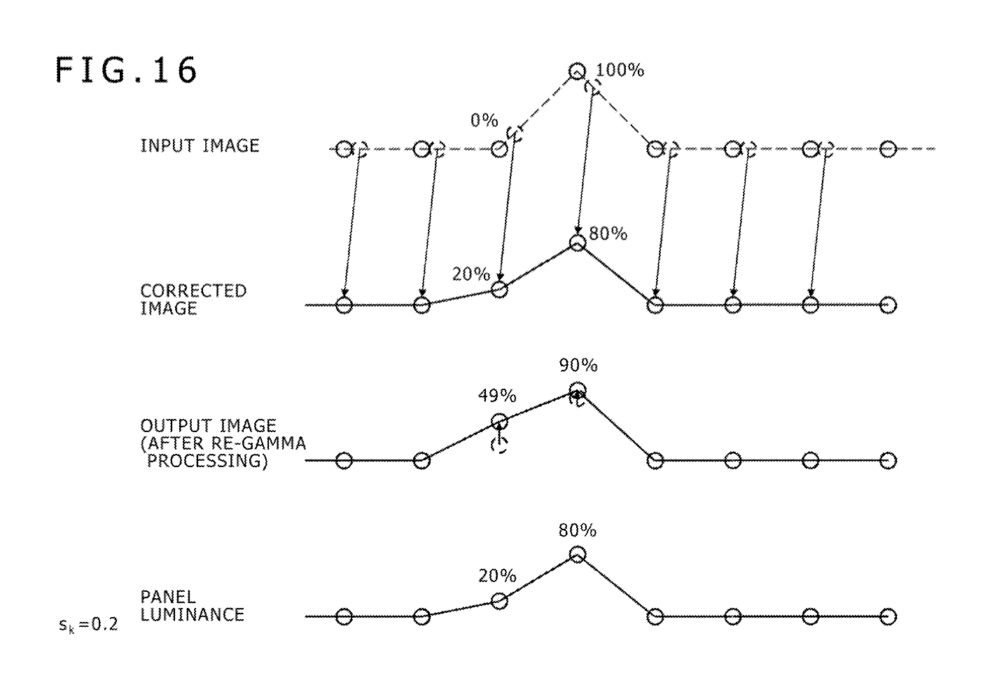

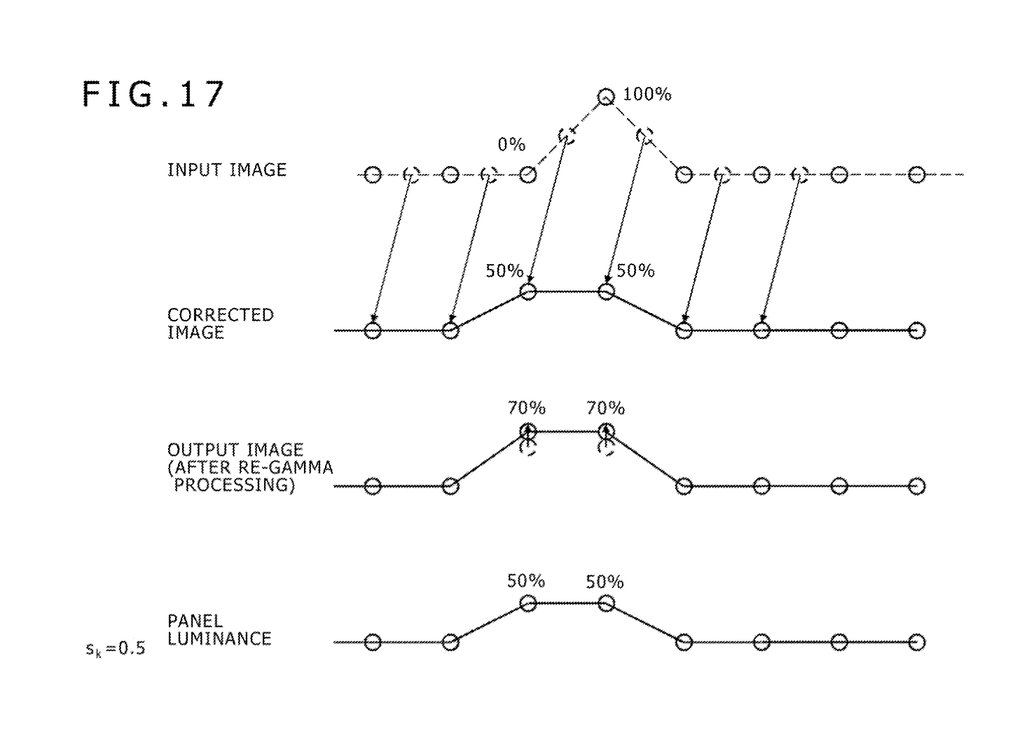

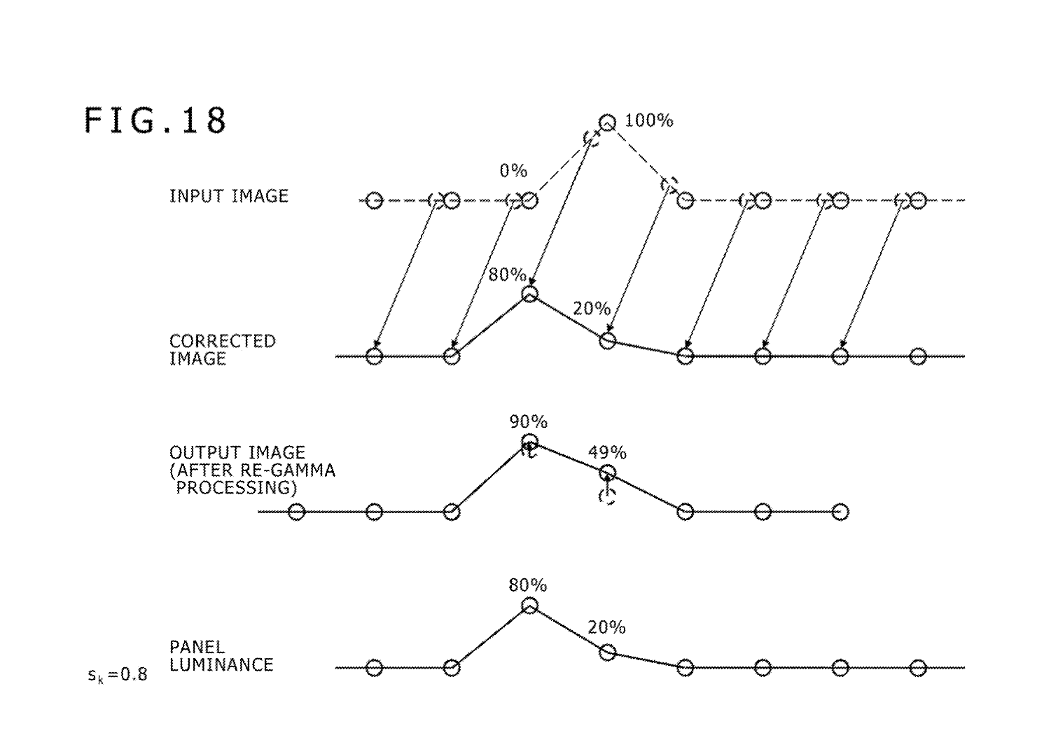

A more detailed consideration will be made below about the behavior in the distortion correction block 301 shown in FIG. 15 when a bright spot of one pixel exists in the input image din. FIGS. 16 to 18 show the values of the corrected image signal dout′ (k) and the output image signal dout(k) resulting from re-gamma processing and the values obtained by converting the output image signal dout(k) to the luminance when the decimal part sₖ of the reference signal ref(k) is changed to 0.2, 0.5, and 0.8 similarly to the above description in the case of performing linear interpolation of the linear input image signal din′ resulting from de-gamma processing in accordance with the above expression (3).

Comparison of the respective diagrams of FIGS. 16 to 18 proves that, although the signal value dout′ (k) of the linear corrected image changes depending on the value of the decimal part sₖ of the reference signal ref(k), the total of the signal value is 20+80=50+50=80+20=100% in each case and the 100% bright spot is distributed into plural pixels.

Furthermore, the signal value of the output image signal dout(k) resulting from the re-gamma processing of the corrected image signal dout′ (k) also changes depending on the value of the decimal part sₖ of the reference signal ref(k). When sₖ=0.2, 0.5, and 0.8, the total of the signal value is 49+90=139%, 70+70=140%, and 90+49=139%, respectively. Moreover, when the respective output image signals dout(k) are converted to the luminance, it turns out that the total of the luminance is 20+80=50+50=80+20=100% in each case and the 100% bright spot is distributed into plural pixels.

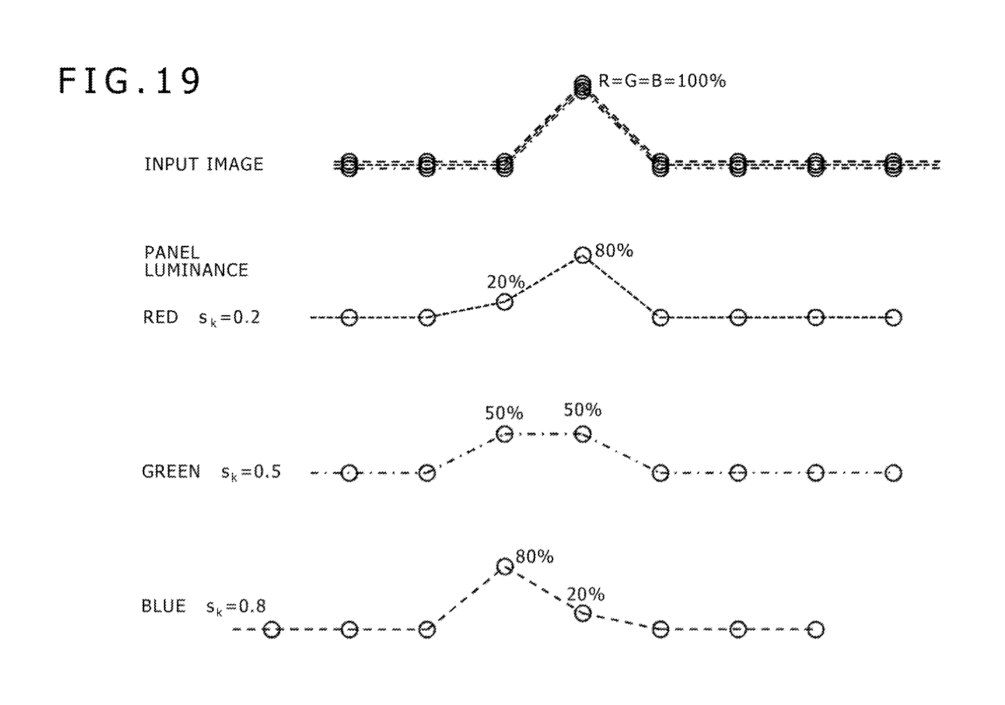

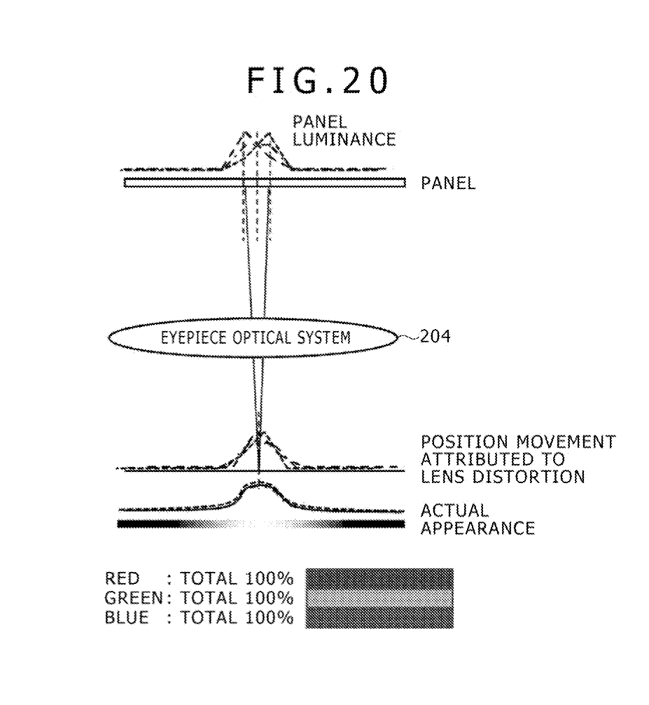

Based on the above, a consideration will be made below about the case in which a 100% white bright spot of one pixel exists in the input image. The reference signals of RGB are different from each other because of the chromatic aberration of the eyepiece optical system 204. For example, if the decimal part of the reference signal ref(k) at a certain output pixel position k is various, specifically R: sₖ=0.2, G: sₖ=0.5, and B: sₖ=0.8, as shown in FIG. 19, the total of the luminance of each color component of RGB is 20+80=50+50=80+20=100% when sₖ=0.2, 0.5, and 0.8, respectively, and it turns out that the 100% bright spot is distributed into plural pixels. The above-described values are the result of display on the display panel of the display section 203. When the image is viewed through the eyepiece optical system 204, the positions of the respective colors correspond with each other and the image is viewed as a normal image as shown in FIG. 20. Furthermore, the totals of the luminance of RGB correspond with each other at 100% and therefore the color that should be white originally is correctly observed as white.

As above, by performing image correction by using the distortion correction black 301 shown in FIG. 15, image quality deterioration due to the correction can be alleviated when images are displayed based on the combination of a display panel and a lens. In particular, the occurrence of color unevenness and the deterioration of fineness can be prevented and it becomes possible to display images with higher image quality.

It is also possible for the technique disclosed in the present specification to employ the following configurations.

(1) A display device including: an image corrector configured to execute correction processing of an input image independently for each color component; a display section configured to display an output image of the image corrector; and an eyepiece optical section configured to project a displayed image of the display section in such a manner that a predetermined angle of view is obtained, wherein the image corrector executes, about each color component, correction processing of distortion generated by the eyepiece optical section after executing de-gamma processing of an input image for which gamma processing has been executed, and executes re-gamma processing to output a resulting image.

(2) The display device according to the above-described (1), wherein the image corrector interpolates a pixel of the output image by a plurality of corresponding pixels on a linear input image resulting from the de-gamma processing.

(3) An image processing device including, for each color component: a de-gamma processor configured to execute de-gamma processing of an input image signal for which gamma processing has been executed; an image corrector configured to execute correction processing of distortion generated in projection by a predetermined eyepiece optical section for a linear input image resulting from the de-gamma processing; and a gamma processor configured to execute re-gamma processing of a linear image resulting from correction and output a resulting image.

(4) An image processing method including, for each color component: executing de-gamma processing of an input image signal for which gamma processing has been executed; executing correction processing of distortion generated in projection by a predetermined eyepiece optical section for a linear input image resulting from the de-gamma processing; and executing re-gamma processing of a linear image resulting from correction and outputting a resulting image.

(5) A computer program that is described in a computer-readable format and is to cause a computer to function as an entity including, for each color component of an input image: a de-gamma processor configured to execute de-gamma processing of an input image signal for which gamma processing has been executed; an image corrector configured to execute correction processing of distortion generated in projection by a predetermined eyepiece optical section for a linear input image resulting from the de-gamma processing; and a gamma processor configured to execute re-gamma processing of a linear image resulting from correction and output a resulting image.

The technique disclosed in the present specification is explained in detail above with reference to a specific embodiment. However, it is obvious that those skilled in the art can make modifications and alternatives of the embodiment without departing from the gist of the technique disclosed in the present specification.

Although the embodiment in which the technique disclosed in the present specification is applied to a head-mounted display is mainly described in the present specification, the gist of the technique disclosed in the present specification is not limited to the configuration of a specific head-mounted display. The technique disclosed in the present specification can be similarly applied also to various types of display system that presents images to the user based on the combination of a display panel and a lens.

In short, the technique disclosed in the present, specification is explained above based on a form of exemplification and the described contents of the present specification should not be interpreted in a limited manner. To determine the gist of the technique disclosed in the present specification, the scope of claims should be taken into consideration.

The present disclosure contains subject matter related to that disclosed in Japanese Priority Patent Application JP 2012-05893 filed in the Japan Patent Office on Mar. 15, 2012, the entire content of which is hereby incorporated by reference.

What is claimed is:

1. A display device comprising:
an image corrector configured to execute correction processing of an input image independently for each color component;
a display section configured to display an output image of the image corrector; and
an eyepiece optical section configured to project a displayed image of the display section in such a manner that a predetermined angle of view is obtained,
wherein the image corrector executes, about each color component, correction processing of distortion generated by the eyepiece optical section after executing de-gamma processing of an input image for which gamma processing has been executed, and executes re-gamma processing to output a resulting image.

2. The display device according to claim 1, wherein
the image corrector interpolates a pixel of the output image by a plurality of corresponding pixels on a linear input image resulting from the de-gamma processing.

3. An image processing device comprising, for each color component:
a de-gamma processor configured to execute de-gamma processing of an input image signal fox which gamma processing has been executed;
an imago corrector configured to execute correction processing of distortion generated in projection by a predetermined eyepiece optical section for a linear input image resulting from the de-gamma processing; and
a gamma processor configured to execute re-gamma processing of a linear image resulting from correction and output a resulting image.

4. An image processing method comprising, for each color component:
executing de-gamma processing of an input image signal for which gamma processing has been executed;
executing correction processing of distortion generated in projection by a predetermined eyepiece optical section for a linear input image resulting from the de-gamma processing; and
executing re-gamma processing of a linear image resulting from correction and outputting a resulting image.

5. A computer program that is described in a computer-readable format and is to cause a computer to function as an entity comprising, for each color component of an input image:
a de-gamma processor configured to execute de-gamma processing of an input image signal for which gamma processing has been executed;
an image corrector configured to execute correction processing of distortion generated in projection by a predetermined eyepiece optical section for a linear input image resulting from the de-gamma processing; and
a gamma processor configured to execute re-gamma processing of a linear image resulting from correction and output a resulting image.
